(19) United States
(12) Patent Application Publication
(10) Pub. No.: US 2006/0261080 A1
(43) Pub. Date: Nov. 23, 2006

(54) Vending machine

(75) Inventors: Naoto Matsumoto, Isesaki-shi (JP); Masaru Ohkubo, Isesaki-shi (JP)

Correspondence Address: BANNER & WITCOFF, 1001 G STREET N W, SUITE 1100, WASHINGTON, DC, 20001, US

(73) Assignee: SANDEN CORPORATION, Isesaki-shi (JP)

(21) Appl. No.: 11/431,099

(22) Filed: May 10, 2006

(30) Foreign Application Priority Data
May 13, 2005 (JP) 140996/2005

(51) Int. Cl. G07F 11/00

(52) U.S. Cl. 221/124

(57) ABSTRACT

A vending machine is configured in such a way that, the speeds of a bucket and an elevator that, upon origin detection, move to respective origin detection positions are reduced at the timing when the bucket and the elevator reach respective speed-reduction positions that are located before the respective origin detection positions, and the bucket and the elevator whose speeds have been reduced activate respective sensors. With the foregoing configuration, compared to the case where the bucket and the elevator whose speeds are not reduced activate the sensors, the respective variation ranges of the activation timings when the sensors are activated are reduced, whereby the respective deviations in the origin detection positions detected by the sensors are reduced.

### BACKGROUND OF THE INVENTION

1. Field of the Invention

The present invention relates to a vending machine that provides a consumer with a selected commodity based on a money insertion and a commodity selection.

2. Description of the Related Art

Some vending machines includes, as a mechanism for providing a consumer with a selected commodity, a movable body capable of linearly moving in a predetermined direction and a movable-body driving mechanism having a motor as a driving source.

For example, a vending machine termed a see-through type has a plurality of commodity containers arranged in a matrix viewed from the front, a bucket capable of linearly moving in a X direction (a right-and-left direction) and in a Z direction (a up-and-down direction), and a bucket driving mechanism for moving the bucket in a two-dimensions within the XZ-coordinate system.

The bucket driving mechanism has an X-axis driving mechanism for moving the bucket in the X direction and a Z-axis driving mechanism for moving the bucket in the Z direction. The driving mechanisms each have a motor, a speed reducer and movement conversion means. A combination of a pair of pulleys and an endless belt around the pair of pulleys and the like are utilized as the movement conversion means. Additionally, an encoder is coupled with the rotation axle of the motor in each of the driving mechanisms. Additionally, bucket stop positions corresponding to the commodity containers and the like are stored in a memory as XZ coordinates (Xₙ, Zₙ) on the basis of the origin (X₀, Z₀).

The vending machine implements a desired commodity vending in such a way that the XZ coordinates (Xₙ, Zₙ) corresponding to a predetermined commodity container storing a selected commodity is read based on a vending command, the bucket is moved to and stopped at the read XZ coordinates (Xₙ, Zₙ), the commodity is fed from the predetermined commodity container into the bucket that has been stopped and the bucket into which the commodity has been fed is moved to the position that faces the commodity vending opening or the like.

The origin (X₀, Z₀) is preliminarily stored upon shipping. However, in order to accurately implement the foregoing series of commodity-vending operation, the origin (X₀, Z₀) is detected again on the occasions of re-turning on power of the vending machine, shutting a door thereof or the like. As for the origin detection, a method has commonly been employed in which the bucket is moved to an origin detection position and at the timing when a sensor provided at the origin detection position is activated, the output signal (pulse signal) from each of encoders is read.

In general, the sensor for detecting the origin detection position consists of a micro switch, an optical sensor or the like. However, depending on the operation accuracy of the bucket driving mechanism, operation conditions including temperature and humidity and the like, the operation timing of the sensor subtly changes each time the origin detection is implemented. For instance, in the case where the resolution of the encoder is 360 (pulse/rotation), the moving distance of the bucket is 0.5 mm/pulse, and at most 5 pulses are included in the variation range of the operation timing, the origin detection position detected by the sensor includes a deviation of at most 2.5 mm. In other words, the origin (X₀, Z₀) to be detected also deviates at most 2.5 mm in each of the Z direction and the X direction, and the bucket stop position corresponding to each commodity container also deviates, therefore, when the commodity is fed from the predetermined commodity container into the bucket that has been stopped, a defective feeding may occur, due to the deviations.

In order to implement the origin detection as accurately as possible under the condition the operation timing of the sensor subtly changes, a contrivance for raising the operation accuracies of the bucket driving mechanisms, a contrivance for maintaining constant the operation conditions including temperature and humidity and the like are additionally required. However, when limited production costs are taken into account, implementations of these contrivances are extremely difficult in effect. In other words, if configurations are employed in which the origin detection can be implemented as accurately as possible by utilizing an origin-detection method which is basically the same as a conventional method, an desired objective can be achieved without raising production costs.

### SUMMARY OF THE INVENTION

The object of the present invention is to provide a vending machine that implements the origin detection as accurately as possible by utilizing an origin-detection method which is basically the same as a conventional method.

In order to achieve the object, the vending machine provided by the present invention includes: a movable body capable of linearly moving in a predetermined direction; a movable-body driving mechanism having a motor as a driving source; an encoder coupled with a rotation axle of the motor of the driving mechanism for detecting position; a sensor provided at an origin detection position and capable of being activated by the movable body; and an origin detector having at least first means, second means and third means, the first means for moving the movable body from a present position toward the origin detection position at a predetermined speed based on an origin detection command, the second means for switching a moving speed of the movable body from the predetermined speed to a reduced speed slower than the predetermined speed at the timing when the movable body moving at the predetermined speed reaches a speed-reduction position located before the origin detection position, the third means for detecting an origin by reading an output signal from the encoder at the timing when the movable body moving at the reduced speed reaches the origin detection position and the sensor is activated.

According to the vending machine, when the origin is detected, the speed of the movable body that moves to the origin detection position is reduced at the timing when the movable body reaches the speed-reduction position located before the respective origin detection position, and the movable body that has been decelerated activates the sensor. Therefore, compared with the case where the movable body whose speed is not reduced activates the sensor, the variation range of the activation timing when the sensor is activated can be reduced. Hence, the deviation in the origin detection position detected by the sensor can be reduced, and the origin detection can be implement as accurately as possible by utilizing the origin-detection method which is basically the same as the conventional method.

The above object and other objects, features and effects of the present invention will be apparent by following descriptions and attached drawings.

### BRIEF DESCRIPTION OF THE DRAWINGS

FIG. 1 is a partial front view of a see-through vending machine representing an embodiment of the present invention;

FIG. 2 is a longitudinal cross-sectional view of commodity containers and a bucket in the vending machine illustrated in FIG. 1;

FIG. 3 is a perspective view of the bucket and a bucket driving mechanism in the vending machine illustrated in FIG. 1;

FIG. 4 is a block diagram of the vending machine illustrated in FIG. 1;

FIG. 5 is a flowchart for origin detection implemented in the vending machine illustrated in FIG. 1;

FIG. 6 is a flowchart for origin detection implemented in the vending machine illustrated in FIG. 1;

FIG. 7 is a partially modified example of the flowchart illustrated in FIGS. 5 and 6; and

FIG. 8 is a partially modified example of the flowchart illustrated in FIGS. 5 and 6.

### DESCRIPTION OF THE PREFERRED EMBODIMENTS

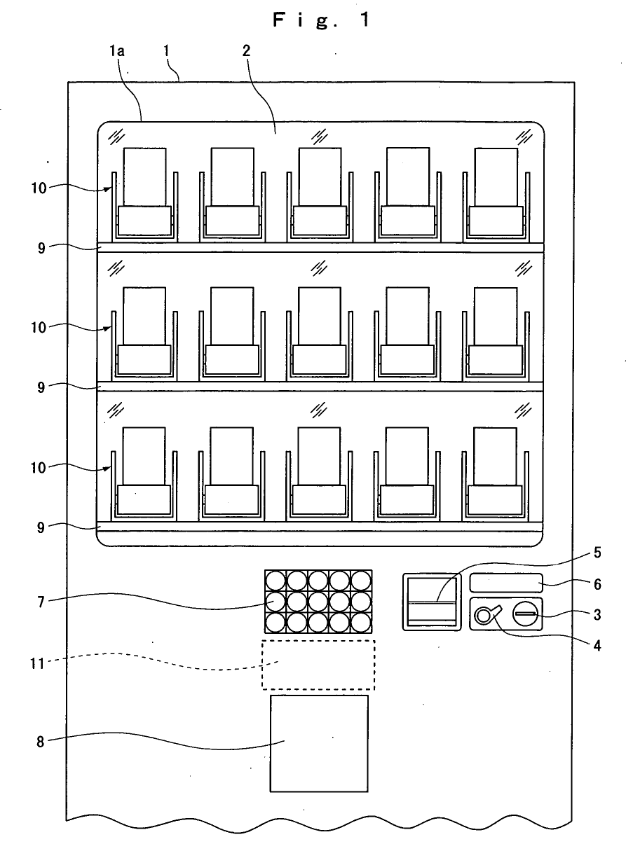

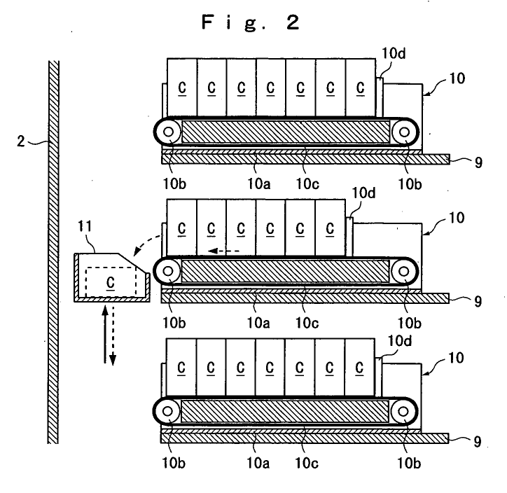

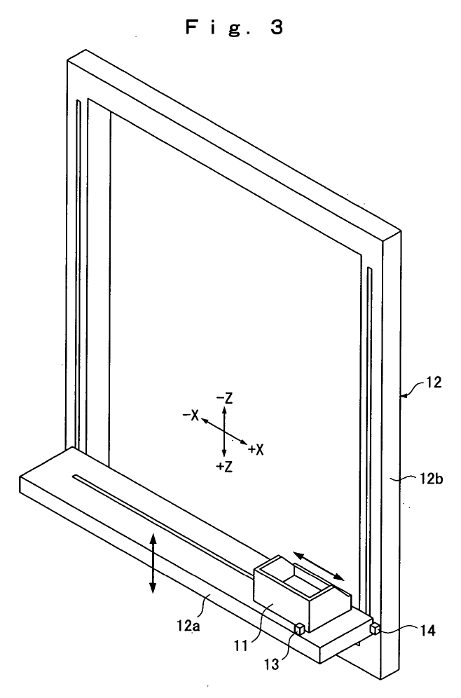

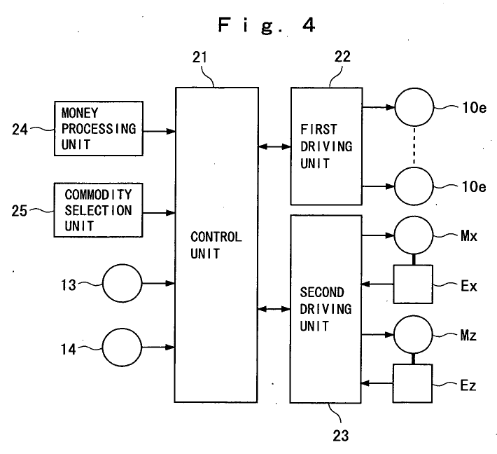

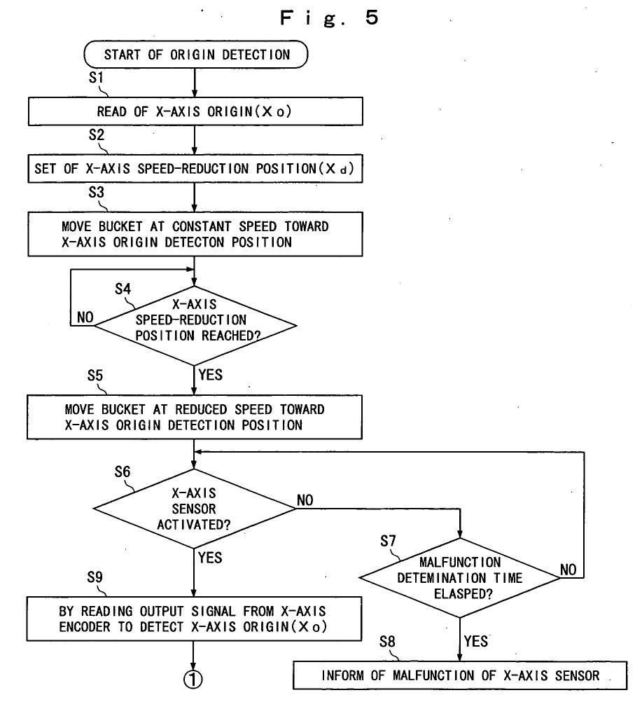

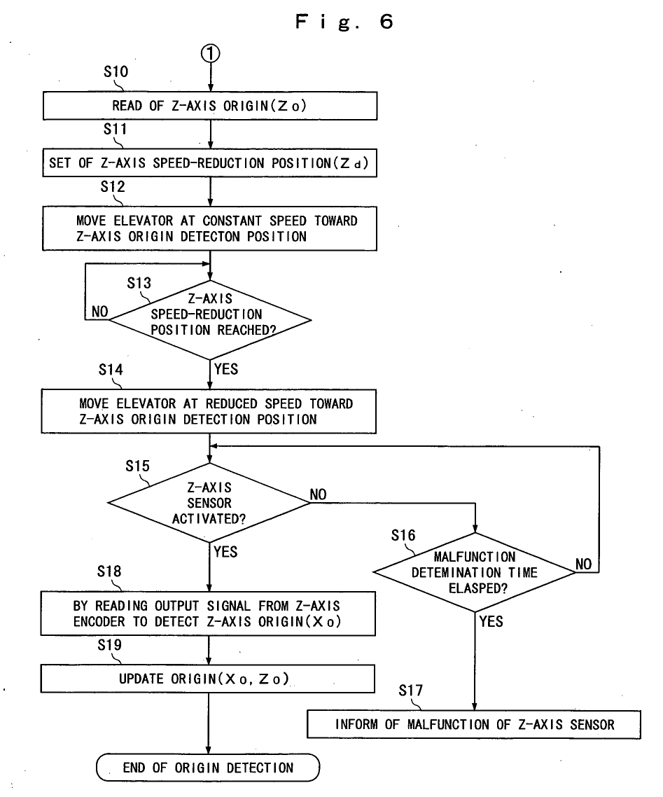

FIGS. 1 to 6 illustrate an embodiment in which the present invention is applied to a see-through vending machine. FIG. 1 is a partial front view of the see-through vending machine; FIG. 2 is a longitudinal cross-sectional view of commodity containers and a bucket in the vending machine illustrated in FIG. 1; FIG. 3 is a perspective view of the bucket and a bucket driving mechanism in the vending machine illustrated in FIG. 1; FIG. 4 is a block diagram of the vending machine illustrated in FIG. 1; and FIGS. 5 and 6 are flowcharts for origin detection implemented in the vending machine illustrated in FIG. 1.

In the first place, the mechanism of the vending machine will be explained with reference to FIGS. 1 to 3.

A cabinet 1 has a main body (no reference character) whose front face is opened and a door (no reference character) that is provided on the front opening of the main body in an openable and closable manner. A window opening 1a is formed in the front top portion of the cabinet 1. A transparent plate 2 made of transparent plastic or the like is provided in the window opening 1a. Additionally, on the front face of the cabinet 1, a coin slot 3, a return lever 4, a bill slot 5, and a display device 6 such as an LCD for displaying the amount of inserted money and the like are provided. Additionally, a plurality of commodity selection buttons 7 and a commodity vending opening 8 are provided on the front face of the cabinet 1.

Inside the cabinet 1, a heat-shielded room (no reference character) is provided. In the heat-shielded room, shelf plates 9 (three plates, in FIG. 1) are provided at intervals in the up-and-down direction. On each of the respective shelf plates 9, commodity containers 10 (five containers, in FIG. 1) are provided at intervals in the right-and-left direction.

Each of the commodity containers 10 is provided with a frame 10a having a U-shaped cross section, a pair of pulleys 10b pivotably provided at the front and the rear of the frame 10a, an endless belt 10c around the pair of pulleys 10b, a commodity pushing plate 10d provided on the upper portion of the belt 10c, and a motor 10e (refer to FIG. 4) having a speed reducer whose rotation axle is coupled with either one of the pair of pulleys 10b. In addition, on the upper portion of the belt 10c in the commodity container 10, commodities C such-as packaged beverages are set out in the front-and-rear direction.

As indicated by a broken-line arrow in FIG. 2, each commodity container 10 can drop forward the foremost commodity C by moving through the motor 10e the belt 10c counterclockwise by a predetermined distance.

The bucket 11 that can linearly move in the X direction (the right-and-left direction) and in the Z direction (the up-and-down direction) and the bucket driving mechanism 12 for moving the bucket in a two-dimensions within the XZ coordinate system are provided between the transparent plate 2 inside the cabinet 1 and the commodity containers 10.

The bucket 11 has the form of a box whose topside is open. As indicated by a broken-line arrow in FIG. 2, the bucket 11 can receive the commodity C dropped from the commodity container 10 in a state where the bucket 11 is located at the front side of a predetermined commodity container 10.

The bucket driving mechanism 12 is provided with an elevator 12a including an X-axis driving mechanism (unillustrated) for moving the bucket 11 in the X direction (the right-and-left direction) and a frame-shaped component 12b including a Z-axis driving mechanism (illustrated) for moving the bucket 11 in the Z direction (the up-and-down direction).

The X-axis driving mechanism has an X-axis motor Mx (refer to FIG. 4), a speed reducer coupled with the rotation axle of the X-axis motor Mx, and movement conversion means coupled with the output axle of the speed reducer. The movement conversion means consists of a combination such as a combination of a pair of right and left pulleys and an endless belt around the pair of pulleys, the bucket 11 is coupled with the belt. Additionally, an X-axis encoder Ex (refer to FIG. 4) is coupled with the rotation axle of the X-axis motor Mx. The X-axis encoder Ex consists of a two-phase rotary encoder that can output a pulse signal whose form corresponds to the forward or reverse rotation of the X-axis motor Mx.

The Z-axis driving mechanism has a Z-axis motor Mz (refer to FIG. 4), a speed reducer coupled with the rotation axle of the Z-axis motor Mz, and movement conversion means coupled with the output axle of the speed reducer. The movement conversion means consists of a combination such as a combination of a pair of top and bottom pulleys and an endless belt around the pair of pulleys, the elevator 12a is coupled with the belt. Additionally, a Z-axis encoder Ez (refer to FIG. 4) is coupled with the rotation axle of the Z-axis motor Mz. The Z-axis encoder Ez consists of a two-phase rotary encoder that can output a pulse signal whose form corresponds to the forward or reverse rotation of the Z-axis motor Mz.

Additionally, an X-axis sensor 13 for detecting an origin detection position in the X direction is provided on the elevator 12a of the bucket driving mechanism 12. A Z-axis sensor 14 for detecting an origin detection position in the Z direction is provided on the frame-shaped component 12b. The sensors 13 and 14 consists of a micro switch, an optical sensor or the like. The X-axis sensor 13 is activated (turned ON or OFF) when the bucket 11 contacts or approaches the X-axis sensor 13. The Z-axis sensor 14 is activated (turned ON or OFF) when the elevator 12a contacts or approaches the Z-axis sensor 14. In FIG. 3, the X-axis sensor 13 and the Z-axis sensor 14 are arranged in such a way that the origin detection positions exist at the right bottom in the view, however, the arrangement positions of the sensors 13 and 14 that specify the origin detection positions may arbitrarily be decided, as long as the sensors 13 and 14 can be activated when the movable bodies (the bucket 11 and the elevator 12a) contact or approach the sensors 13 and 14 respectively.

In this embodiment, the bucket 11 and the elevator 12a correspond to “movable body” as termed in the claims, the X-axis and Z-axis driving mechanisms in the bucket driving mechanism 12 correspond to “movable-body driving mechanism” as termed in the claims.

Next, the control system of the vending machine will be explained with reference to FIG. 4.

A control unit 21 includes a computer whose memory stores a program related to vending of the commodities, a program related to detection of the origin and the like. Additionally, in addition to the origin (X₀, Z₀) of the operation of the bucket 11, the respective bucket stop positions for the commodity containers 10, the bucket stop position for the commodity vending opening 8 and the bucket stop position corresponding to the standby position are stored in the memory as XZ coordinates (Xₙ, Zₙ) on the basis of the origin (X₀, Z₀).

A first driving unit 22 transmits a driving signal to the motor 10e of each of the commodity containers 10 based on a control signal from the control unit 21. A second driving unit 23 transmits based on a control signal from the control unit 21, respective driving signals to the X-axis motor Mx in the X-axis driving mechanism and the Z-axis motor Mz of the Z-axis driving mechanism, detects respective output signals (pulse signals) from the X-axis encoder Ex and the Z-axis encoder Ez and transmits the detected output signals to the control unit 21.

A money processing unit 24 includes the coin slot 3, the return lever 4, the bill slot 5 and the display device 6. The money processing unit 24 implements true/false judgment on money inserted through at least one of the coin slot 3 and the bill slot 5, return of false money and defective money, counting and retention of true money, transmission to the control unit 21 of the counted value for true money, return of change based on the operation of the return lever 4 and the like. The display device 6 implements display of the amount of inserted money based on a control signal from the control unit 21.

A commodity selection unit 25 includes the commodity selection buttons 7. The commodity selection unit 25 transmits to the control unit 21 a signal for requesting the vending of the commodity C corresponding to that commodity selection button 7 when any one of the commodity selection buttons 7 is pressed after true money that is worth more than the price of a commodity has been inserted.

Next, the commodity vending implemented by the foregoing vending machine will be explained. In this embodiment, a vending command is issued under the condition that true money that is worth more than a commodity price is inserted through at least one of the coin slot 3, and the bill slot 5 and any one of the commodity selection buttons 7 is pressed.

When the vending command is issued, the XZ coordinates (Xₙ, Zₙ) corresponding to the predetermined commodity container 10 containing the selected commodity C is read from the memory. Thereafter, a control signal for moving toward the read XZ coordinates (Xₙ, Zₙ) and halting the bucket 11 is transmitted to the second driving unit 23, and respective predetermined driving signals are transmitted to the X-axis motor Mx in the X-axis driving mechanism and to the Z-axis motor Mz in the Z-axis driving mechanism from the second driving unit 23. Therefore, as illustrated in FIG. 2, the bucket 11 that has been in the standby position (refer to FIG. 1) moves to and stops at the front side of the predetermined commodity container 10.

After the bucket 11 stops, a control signal for dropping forward the foremost commodity C in the predetermined commodity container 10 is issued to the first driving unit 22, and a predetermined driving signal is transmitted to the motor 10e for the predetermined commodity container 10 from the first driving unit 22. Therefore, as illustrated in FIG. 2, the foremost commodity C in the predetermined commodity container 10 is fed into the bucket 11. Whether or not the commodity C has been fed into the bucket 11 is detected by a sensor (unillustrated) provided in the bucket 11 for detecting the presence or absence of a commodity.

After the commodity C is fed into the bucket 11, the XZ coordinates (Xₙ, Zₙ) corresponding to the commodity vending opening 8 is read from the memory. Thereafter, a control signal for moving toward the read XZ coordinates (Xₙ, Zₙ) and halting the bucket 11 is transmitted to the second driving unit 23, and respective predetermined driving signals are transmitted to the X-axis motor Mx in the X-axis driving mechanism and the Z-axis motor Mz in the Z-axis driving mechanism from the second driving unit 23. Therefore, the bucket 11 that has been at the commodity feeding position moves toward and stops at the back side of the commodity vending opening 8.

After the commodity C in the bucket 11 is taken out by a consumer through the commodity vending opening 8, the XZ coordinates (Xₙ, Zₙ) corresponding to the standby position is read from the memory. Thereafter, a control signal for moving toward the read XZ coordinates (Xₙ, Zₙ) and halting the bucket 11 is transmitted to the second driving unit 23, and respective predetermined driving signals are transmitted to the X-axis motor Mx in the X-axis driving mechanism and the Z-axis motor Mz in the Z-axis driving mechanism from the second driving unit 23. Therefore, the bucket 11 that has been at the commodity vending position moves toward and stops at the standby position. At this point, a series of the commodity vending is completed.

Next, the origin detection implemented in the vending machine will be explained with reference to FIGS. 5 and 6. In this embodiment, an origin detection command is issued on the occasions of re-turning on power of the vending machine, shutting the door thereof or the like.

When the origin detection command is issued, the last detected X-axis origin (X₀) is read from the memory, an X-axis speed-reduction position (X_{d}) is set based on the read X-axis origin (X₀) (the steps S1 and S2 in FIG. 5).

The X-axis speed-reduction position (X_{d}) may basically be set at any position as long as the position is before the X-axis origin (X₀). However, if the distance between the X-axis speed-reduction position (X_{d}) and the X-axis origin (X₀) is long, the time in which the bucket 11 reaches the X-axis origin detection position becomes long. In contrast, if the distance between the X-axis speed-reduction position (X_{d}) and the X-axis origin (X₀) is short, the desired purpose may not be achieved. Hence, in this embodiment, the X-axis speed-reduction position (X_{d}) is set 10 to 30 mm before the X-axis origin (X₀).

After the X-axis speed-reduction position (X_{d}) is set, a control signal for moving the bucket 11 from a present position (e.g., the standby position) toward the X-axis origin detection position (where the X-axis sensor 13 is provided) is transmitted to the second driving unit 23, a predetermined driving signal is transmitted to the X-axis motor Mx in the X-axis driving mechanism from the second driving unit 23. Therefore, the bucket 11 moves in the +X direction in FIG. 3 at a predetermined speed, e.g., 400 mm/sec from the present position (the step S3 in FIG. 5). In addition, the predetermined speed in this situation is set to be equal to or lower than the speed at which the bucket 11 moves in the X direction upon commodity vending.

After the bucket 11 starts to move, whether or not the bucket 11 has reached the X-axis speed-reduction position (X_{d}) is determined based on the output signal from the X-axis encoder Ex (the step S4 in FIG. 5).

After the bucket 11 reaches the X-axis speed-reduction position (X_{d}), a control signal for switching the moving speed of the bucket 11 from the predetermined speed to a reduced speed is transmitted to the second driving unit 23, and a predetermined driving-signal is transmitted to the X-axis motor Mx in the X-axis driving mechanism from the second driving unit 23. Therefore, the bucket 11 moves in the +X direction in FIG. 3 at the reduced speed, e.g., 80 mm/sec from the X-axis speed-reduction position (X_{d}) (the step S5 in FIG. 5). In addition, the reduced speed in this situation is set to be within 10 to 50%, preferably within 10 to 30% of the predetermined speed.

After the speed of the bucket 11 has been reduced, whether or not the bucket 11 has reached the origin detection position is determined based on the operation (ON or OFF) of the X-axis sensor 13 (the step S6 in FIG. 5).

The elapsed time from the timing when the bucket 11 has started to move is separately measured in the step S3. When the measured elapsed time exceeds a malfunction determination time, it is considered that a failure, wire breaking, falling or the like exists in the X-axis sensor 13, and it is informed that some sort of malfunction exists in the X-axis sensor 13 (the steps S7 and S8 in FIG. 5). In addition, as for the information, in addition to a method of activating an alarm such as a buzzer provided in the vending machine, for example, a method in which the display device 6 displays an error message can be employed.

When the X-axis sensor 13 is activated within the malfunction determination time, the output signal from the X-axis encoder Ex is read at the timing when the X-axis sensor 13 is activated, and a X-axis origin (X₀) is detected based on that output signal (the step S9 in FIG. 5). The detected X-axis origin (X₀) is temporarily stored in the memory.

After the X-axis origin (X₀) is stored, the last detected Z-axis origin (Z₀) is read from the memory, a Z-axis speed-reduction position (Z_{d}) is set based on the read Z-axis origin (Z₀) (the steps S10 and S11 in FIG. 6).

The Z-axis speed-reduction position (Z_{d}) may basically be set at any position as long as the position is before the Z-axis origin (Z₀). However, if the distance between the Z-axis speed-reduction position (Z_{d}) and the Z-axis origin (Z₀) is long, the time in which the elevator 12a reaches the Z-axis origin detection position becomes long. In contrast, if the distance between the Z-axis speed-reduction position (Z_{d}) and the Z-axis origin (Z₀) is short, the desired purpose may not be achieved. Hence, in this embodiment, the Z-axis speed-reduction position (Z_{d}) is set 10 to 30 mm before the Z-axis origin (Z₀).

After the Z-axis speed-reduction position (Z_{d}) is set, a control signal for moving the elevator 12a, on which the bucket 11 is mounted, from a present position (e.g., the X-axis origin detection position) toward the Z-axis origin detection position (where the Z-axis sensor 14 is provided) is transmitted to the second driving unit 23, a predetermined control signal is transmitted to the Z-axis motor Mz in the Z-axis driving mechanism from the second driving unit 23. Therefore, the elevator 12a moves in the +Z direction in FIG. 3 at a predetermined speed, e.g., 400 mm/sec from the present position (the step S12 in FIG. 6). In addition, the predetermined speed in this situation is set to be equal to or lower than the speed at which the elevator 12a moves in the Z direction upon commodity vending,.

After the elevator 12a starts to move, whether or not the elevator 12a has reached the Z-axis speed-reduction position (Z_{d}) is determined based on the output signal from the Z-axis encoder Ez (the step S13 in FIG. 6).

After the elevator 12a reaches the Z-axis speed-reduction position (Z_{d}), a control signal for switching the moving speed of the elevator 12a from the predetermined speed to a reduced speed is transmitted to the second driving unit 23, and a predetermined driving signal is transmitted to the Z-axis motor Mz in the Z-axis driving mechanism from the second driving unit 23. Therefore, the elevator 12a moves in the +Z direction in FIG. 3 at the reduced speed, e.g., 80 mm/sec from the Z-axis speed-reduction position (Z_{d}) (the step S14 in FIG. 6). In addition, the reduced speed in this situation is set to be within 10 to 50%, preferably within 10 to 30% of the predetermined speed.

After the speed of the elevator 12a has been reduced, whether or not the elevator 12a has reached the origin detection position is determined based on the operation (ON or OFF) of the Z-axis sensor 14 (the step S15 in FIG. 6).

The elapsed time from the timing when the elevator 12a has started to move is separately measured in the step S12. When the measured elapsed time exceeds a malfunction determination time, it is considered that a failure, wire breaking, falling or the like exists in the Z-axis sensor 14, and it is informed that some sort of malfunction exists in the Z-axis sensor 14 (the steps S16 and S17 in FIG. 6). In addition, as for the information, in addition to a method of activating an alarm such as a buzzer provided in the vending machine, for example, a method in which the display device 6 displays an error message can be employed.

When the Z-axis sensor 14 is activated within the malfunction determination time, the output signal from the Z-axis encoder Ez is read at the timing when the Z-axis sensor 14 is activated, and a Z-axis origin (Z₀) is detected based on that output signal (the step S18 in FIG. 6). The detected Z-axis origin (Z₀) is temporarily stored in the memory.

After the Z-axis origin (Z₀) is stored, the origin (X₀, Z₀) is decided based on the last X-axis origin (X₀) that has been stored and the Z-axis origin (Z₀), and the last decided origin (X₀, Z₀) is updated to that new origin (X₀, Z₀) (the step S19 in FIG. 6).

As described above, in the foregoing vending machine, when the origin is detected, the speeds of the bucket 11 and the elevator 12a that move to the respective origin detection positions are reduced at the timing when the bucket 11 and the elevator 12a reach the respective speed-reduction positions located-before the respective origin detection positions, and the bucket 11 and the elevator 12a that have been decelerated activate the sensors 13 and 14 respectively. Therefore, compared with the case where the bucket 11 and the elevator 12a whose speeds are not reduced activate the sensors 13 and 14 respectively, the respective variation ranges of the activation timings when the sensors 13 and 14 are activated can be reduced. Hence, the respective deviations in the origin detection positions detected by the sensors 13 and 14 can be reduced, and the origin detection can be implement as accurately as possible by utilizing the origin-detection method which is basically the same as the conventional method.

Moreover, in the foregoing vending machine, the respective speed-reduction positions are set based on the last detected X-axis origin (X₀) and Z-axis origin (Z₀). Therefore, it can be avoided that each speed-reduction position closely approaches or overlaps the corresponding origin detection position, and the speed-reduction positions can be set that are optimal to obtain the foregoing effect.

Still moreover, in the foregoing vending machine, in the case where the measured elapsed time from the timing when the bucket 11 has started to move exceeds the malfunction determination time, or in the case where the measured elapsed time from the timing when the elevator 12a has started to move exceeds the malfunction determination time, it is considered that the failure, wire breaking, falling or the like exists in the sensor 13 or 14, and the malfunction is informed. Therefore, it is possible to timely become aware of the malfunction in the sensor 13 or 14 and to rapidly start repair or the like.

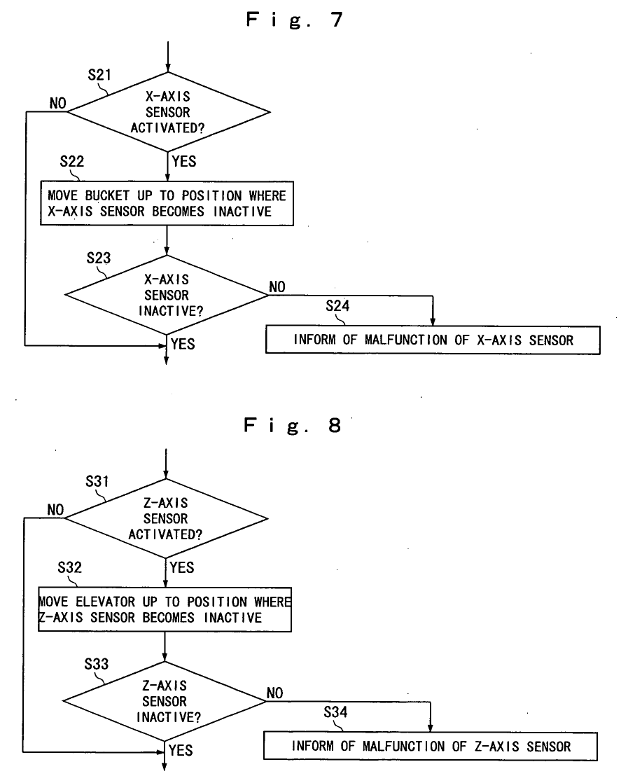

In addition, in the foregoing origin detection, it has been assumed that the X-axis sensor 13 and the Z-axis sensor 14 are inactive upon the start of the origin detection. However, for example, in the case where the standby position of the bucket 11 is at the origin detection position, the X-axis sensor 13 and the Z-axis sensor 14 become active upon the start of the origin detection, so that the origin detection illustrated in FIGS. 5 and 6 cannot be implemented. Therefore, in the case where a case such as this may occur, the process (from the step S21 to the step S24) illustrated in FIG. 7 may be implemented before the step S1 in FIG. 5, and the process (from the step S31 to the step S34) illustrated in FIG. 8 may be implemented before the step S10 in FIG. 9.

Specifically, when an origin detection command is issued, in the first place, whether or not the X-axis sensor 13 is active is determined (the step S21 in FIG. 7). In the case where the X-axis sensor 13 is inactive, the step SI in FIG. 5 follows the step S21. In contrast, in the case where the X-axis sensor 13 is active, the bucket 11 is moved in the X direction to a parting position where the X-axis sensor 13 becomes inactive (the step S22 in FIG. 7). When, even though the bucket 11 is moved to the parting position, the X-axis sensor 13 does not become inactive, it is considered that a failure, wire breaking, falling or the like exists in the X-axis sensor 13, and it is informed that some sort of malfunction exists in the X-axis sensor 13 (the steps S23 and S24 in FIG. 7). In addition, as for the information, in addition to a method of activating an alarm such as a buzzer provided in the vending machine, for example, a method in which the display device 6 displays an error message can be employed.

Meanwhile, after a new X-axis origin (X₀) has been stored, in the first place, whether or not the Z-axis sensor 14 is active is determined (the step S31 in FIG. 8). In the case where the Z-axis sensor 14 is inactive, the step S10 in FIG. 6 follows the step S31. In contrast, in the case where the Z-axis sensor 14 is active, the elevator 12a is moved in the Z direction to a parting position where the Z-axis sensor 14 becomes inactive (the step S32 in FIG. 8). When, even though the elevator 12a is moved to the parting position, the Z-axis sensor 14 does not become inactive, it is considered that a failure, wire breaking, falling or the like exists in the Z-axis sensor 14, and it is informed that some sort of malfunction exists in the Z-axis sensor 14 (the steps S33 and S34 in FIG. 8). In addition, as for the information, in addition to a method of activating an alarm such as a buzzer provided in the vending machine, for example, a method in which the display device 6 displays an error message can be employed.

Moreover, in the foregoing origin detection, the speed-reduction positions for decelerating the movable bodies (the bucket 11 and the elevator 12a) have been set as position information items (the X-axis speed-reduction position (X_{d}) and the Z-axis speed-reduction position (Z_{d})), however, the speed-reduction positions can be set as time information items. In other words, when the movable body is moved at a predetermined speed, the necessary time for the movable body to move from a present position to the origin detection position can be computed based on the corresponding XZ coordinates of the present position, the last detected origin (X₀, Z₀) and the moving speed of the movable body. Therefore, by specifying as the speed-reduction position the timing when the measured elapsed time from the timing when the movable body has started to move reaches 70 to 90% of the necessary time, the speed-reduction position can be set based on the time information item.

Still moreover, in the foregoing origin detection, the method has been explained in which, by detecting the X-axis origin (X₀) and the Z-axis origin (Z₀), the operational origin (X₀, Z₀) in the XZ-coordinate system is decided. However, in a vending machine provided with a driving mechanism for moving in an XYZ-coordinate system a movable body such as a bucket in a three-dimensions, by utilizing the same method to detect the Y-axis origin (Y₀), the operational origin (X₀, Y₀, Z₀) in the XYZ-coordinate system can also be decided. It goes without saying that, also in a vending machine provided with a driving mechanism for moving a movable body such as a bucket in a one-dimension, by utilizing the same method to detect the single-axis origin, the operational origin may be decided.

Furthermore, in the section of the present embodiment, the embodiment has been described in which the present invention is applied to the see-through type vending machine. However, any type of vending machine, which has a movable body capable of linearly moving in the predetermined direction and a movable-body driving mechanism having a motor as a driving source as a mechanism for providing a consumer with a selected commodity, can obtain the same operation and effects as the described above by being applied the present invention.

The preferred embodiments described above are illustrative and not restrictive. The scope of the present invention is recited in the appended claims, and all variant examples within the subject matters of the claims should be included in the present invention.

What is claimed is:

1. A vending machine, comprising:
a movable body capable of linearly moving in a predetermined direction;
a movable-body driving mechanism having a motor as a driving source;
an encoder coupled with a rotation axle of the motor of the driving mechanism for detecting position;
a sensor provided at an origin detection position and capable of being activated by the movable body; and
an origin detector having at least first means, second means and third means, the first means for moving the movable body from a present position toward the origin detection position at a predetermined speed based on an origin detection command, the second means for switching a moving speed of the movable body from the predetermined speed to a reduced speed slower than the predetermined speed at the timing when the movable body moving at the predetermined speed reaches a speed-reduction position located before the origin detection position, the third means for detecting an origin by reading an output signal from the encoder at the timing when the movable body moving at the reduced speed reaches the origin detection position and the sensor is activated.

2. The vending machine according to claim 1, wherein
the second means includes means for setting the speed-reduction position based on a last detected origin.

3. The vending machine according to claim 1, wherein
the third means includes means for informing of a malfunction of the sensor when the sensor is not activated even though a predetermined time has elapsed after the movable body starts to move by the first means.

4. The vending machine according to claim 2, wherein
the third means includes means for informing of a malfunction of the sensor when the sensor is not activated even though a predetermined time has elapsed after the movable body starts to move by the first means.

5. The vending machine according to claim 1, wherein
the first means includes means for determining an activation condition of the sensor when receiving the origin detection and moving the movable body to a parting position where the sensor becomes inactive when the sensor is active.

6. The vending machine according to claim 2, wherein
the first means includes means for determining an activation condition of the sensor when receiving the origin detection command and moving the movable body to a parting position where the sensor becomes inactive when the sensor is active.

7. The vending machine according to claim 3, wherein
the first means includes means for determining an activation condition of the sensor when receiving the origin detection command and moving the movable body to a parting position where the sensor becomes inactive when the sensor is active.

8. The vending machine according to claim 4, wherein
the first means includes means for determining an activation condition of the sensor when receiving the origin detection command and moving the movable body to a parting position where the sensor becomes inactive when the sensor is active.

9. The vending machine according to claim 5, wherein
the first means includes means for inform of a malfunction of the sensor when the sensor does not become inactive even though the movable body has moved to the parting position where the sensor becomes inactive.

10. The vending machine according to claim 6, wherein
the first means includes means for inform of a malfunction of the sensor when the sensor does not become inactive even though the movable body has moved to the parting position where the sensor becomes inactive.

11. The vending machine according to claim 7, wherein
the first means includes means for inform of a malfunction of the sensor when the sensor does not become inactive even though the movable body has moved to the parting position where the sensor becomes inactive.

12. The vending machine according to claim 8, wherein
the first means includes means for inform of a malfunction of the sensor when the sensor does not become inactive even though the movable body has moved to the parting position where the sensor becomes inactive.
